(19) United States
(12) Patent Application Publication
(10) Pub. No.: US 2026/0299985 A1
(43) Pub. Date: Oct. 1, 2026

(54) MIGRATION OF VIRTUAL MACHINES

(71) Applicant: Arm Limited, Cambridge (GB)

(72) Inventors: Djordje KOVACEVIC, Hitchin (GB); Mathias Sven Lucien Alain BROSSARD, Austin, TX (US); Gareth Rhys STOCKWELL, Cambridge (GB); Suzuki Kuruppassery POULOSE, Cambridge (GB)

(21) Appl. No.: 19/091,114

(22) Filed: Mar. 26, 2025

(51) Int. Cl. G06F 9/455; G06F 21/54

(52) U.S. Cl. CPC G06F 9/45558; G06F 21/54; G06F 2009/4557; G06F 2009/45583; G06F 2009/45587

(57) ABSTRACT

An apparatus has management circuitry to cause a migration of a virtual machine from a source processing platform to a destination processing platform, so that a future execution of program instructions associated with the virtual machine are executed by destination processing circuitry of the destination processing platform instead of source processing circuitry of the source processing platform. The management circuitry causes the migration by causing a number of data pages belonging to the virtual machine to be migrated from a source memory device of the source processing platform to a destination memory device of the destination processing platform. Integrity checking circuitry is provided to check integrity of the virtual machine during the migration. Tracking storage is used to maintain tracking information indicative of progress of the migration. The management circuitry is configured to employ a plurality of migration streams to perform the migration, where each migration stream is allocated an associated memory region that is mutually exclusive to a memory region allocated to any other migration stream in the plurality of migration streams, and each migration stream is used to migrate data pages within its associated memory region. The integrity checking circuitry uses the tracking information to assess whether a set of integrity checking rules are satisfied, and prevents the migration proceeding to a phase where program instructions of the virtual machine are permitted to be executed by the destination processing circuitry unless the set of integrity checking rules are satisfied. The set of integrity checking rules are determined taking into account that any given data page is constrained to be migrated using the migration stream whose associated memory region contains the given data page.

### BACKGROUND

The present technique relates to the field of data processing, and more particularly to techniques for migrating a virtual machine from a source processing platform to a destination processing platform.

A virtual machine can be thought of as a set of virtual resources backed by a set of physical resources that may be shared with other virtual machines. Sometimes, it is necessary for the virtual machine to be migrated, by management circuitry, to a new set of physical resources (e.g. due to congestion). In order to migrate a virtual machine, the data pages used by the virtual machine need to be migrated from a memory device of a source processing platform to a memory device of a destination processing platform.

If the entirety of this process were to be performed via cold migration, where execution of the virtual machine is paused and the data pages are moved from the source processing platform to the destination processing platform prior to resuming execution of the virtual machine on the destination processing platform, this could require significant downtime for the virtual machine, and hence have a significant impact on performance. Hence, it is known to use a live migration process where at least some of the data pages are migrated whilst the virtual machine is still running on the source processing platform (note that a live migration does not require that the entire migration happens live—merely that part of the migration is live). Whilst this can reduce downtime of the virtual machine, the use of live migration increases complexity as the data pages may be altered after they have been migrated, and hence may need to be transmitted more than once and/or copies of data pages may need to be invalidated within the memory device of the destination processing platform.

It is hence important to take steps to ensure the integrity of the virtual machine when performing such a live migration. In particular, at the point during live migration where running of the virtual machine is transitioned from the source processing platform to the destination processing platform, it is important that, for any given data page, the memory device of the destination processing platform should either store the most up-to-date version of the content of that given data page, or should not be storing a copy of the given data page at all (it being noted that if a valid copy of the given data page is not present on the memory device of the destination processing platform by the time the virtual machine begins executing on the destination processing platform, a copy of the current content of that given data page can still subsequently be obtained from the source processing platform).

It would be desirable to reduce the cost and complexity of the resources that are required to ensure the integrity of the virtual machine when performing live migration.

### SUMMARY

In accordance with a first example arrangement, there is provided an apparatus comprising: management circuitry configured to cause a migration of a virtual machine from a source processing platform to a destination processing platform, so that a future execution of program instructions associated with the virtual machine are executed by destination processing circuitry of the destination processing platform instead of source processing circuitry of the source processing platform, wherein the management circuitry is configured to cause the migration by causing a number of data pages belonging to the virtual machine to be migrated from a source memory device of the source processing platform to a destination memory device of the destination processing platform; integrity checking circuitry configured to check integrity of the virtual machine during the migration; and tracking storage used to maintain tracking information indicative of progress of the migration; wherein: the management circuitry is configured to employ a plurality of migration streams to perform the migration, where each migration stream is allocated an associated memory region that is mutually exclusive to a memory region allocated to any other migration stream in the plurality of migration streams, and each migration stream is used to migrate data pages within its associated memory region; and the integrity checking circuitry is configured to use the tracking information to assess whether a set of integrity checking rules are satisfied, and to prevent the migration proceeding to a phase where program instructions of the virtual machine are permitted to be executed by the destination processing circuitry unless the set of integrity checking rules are satisfied, wherein the set of integrity checking rules are determined taking into account that any given data page is constrained to be migrated using the migration stream whose associated memory region contains the given data page.

In accordance with a second example arrangement, there is provided a method of migrating a virtual machine from a source processing platform to a destination processing platform, comprising: causing, by management circuitry, a migration of the virtual machine from the source processing platform to the destination processing platform, so that a future execution of program instructions associated with the virtual machine are executed by destination processing circuitry of the destination processing platform instead of source processing circuitry of the source processing platform, wherein the migration causes a number of data pages belonging to the virtual machine to be migrated from a source memory device of the source processing platform to a destination memory device of the destination processing platform; employing a plurality of migration streams to perform the migration, where each migration stream is allocated an associated memory region that is mutually exclusive to a memory region allocated to any other migration stream in the plurality of migration streams, and each migration stream is used to migrate data pages within its associated memory region; and checking, by integrity checking circuitry, integrity of the virtual machine during the migration with reference to tracking information maintained to indicate progress of the migration, the checking comprising using the tracking information to assess whether a set of integrity checking rules are satisfied, and to prevent the migration proceeding to a phase where program instructions of the virtual machine are permitted to be executed by the destination processing circuitry unless the set of integrity checking rules are satisfied, wherein the set of integrity checking rules are determined taking into account that any given data page is constrained to be migrated using the migration stream whose associated memory region contains the given data page.

In accordance with a further example arrangement, there is provided a computer readable medium comprising a computer program configured, when executed by a computer, to: provide a plurality of migration streams for use in performing a migration of a virtual machine from a source processing platform to a destination processing platform, so that a future execution of program instructions associated with the virtual machine are executed by destination processing circuitry of the destination processing platform instead of source processing circuitry of the source processing platform, the migration comprising transfer of a number of data pages belonging to the virtual machine from a source memory device of the source processing platform to a destination memory device of the destination processing platform; allocate each migration stream an associated memory region that is mutually exclusive to a memory region allocated to any other migration stream in the plurality of migration streams, such that each migration stream is used to migrate data pages within its associated memory region; use tracking information indicating progress of the migration to assess whether a set of integrity checking rules are satisfied; and prevent the migration proceeding to a phase where program instructions of the virtual machine are permitted to be executed by the destination processing circuitry unless the set of integrity checking rules are satisfied; wherein the set of integrity checking rules are determined taking into account that any given data page is constrained to be migrated using the migration stream whose associated memory region contains the given data page. The computer readable medium may be a transitory computer readable medium (such as wired or wireless transmission of code over a network) or a non-transitory computer readable medium such as semiconductor, magnetic disk, or optical disc.

In accordance with a yet further example arrangement, there is provided a system comprising: an apparatus in accordance with the first example arrangement discussed above, implemented in at least one packaged chip; at least one system component; and a board, wherein the at least one packaged chip and the at least one system component are assembled on the board. In an additional example arrangement, the above-mentioned system may be assembled on a further board with at least one other product component.

### BRIEF DESCRIPTION OF THE DRAWINGS

Further aspects, features and advantages of the present technique will be apparent from the following description of examples, which is to be read in conjunction with the accompanying drawings, in which:

FIG. 1 illustrates a system in accordance with one example implementation;

FIG. 2 shows an example of one of the hosts shown in FIG. 1, in accordance with one example implementation;

FIG. 3 schematically illustrates the process of live migration in an implementation where the virtual machine being migrated is a confidential virtual machine, in accordance with one example implementation;

FIG. 4 is a state diagram illustrating how the migration status of any given data page may be transitioned between three different migration states, in accordance with one example implementation;

FIG. 5 is a diagram schematically illustrating the creation of migration packages during a pre-copy phase of live migration, in accordance with one approach where the techniques described herein are not utilised;

FIGS. 6A and 6B provide a flow diagram illustrating steps taken during the migration of a confidential virtual machine, in accordance with one example implementation;

FIG. 7 is a flow diagram illustrating how mutually exclusive memory regions are allocated to each of a plurality of migration streams, in accordance with one example implementation;

FIG. 8 is a diagram schematically illustrating a two stage, multiple level, page table walk process that may be used to translate a virtual address into a physical address, in accordance with one example implementation;

FIG. 9 is a diagram schematically illustrating the creation of migration packages during a pre-copy phase of live migration, in accordance with one example implementation;

FIG. 10 is a flow diagram illustrating how various counters used to provide tracking information may be updated during the performance of live migration, in accordance with one example implementation;

FIG. 11 is a flow diagram illustrating steps performed in order to assess whether a set of integrity checking rules are satisfied, in accordance with one example implementation;

FIG. 12 schematically illustrates the process of live migration in an implementation where the virtual machine being migrated is a non-confidential virtual machine, in accordance with one example implementation; and

FIG. 13 illustrates a system and a chip-containing product.

### DESCRIPTION OF EXAMPLES

Before discussing example implementations with reference to the accompanying figures, the following description of some example implementations is provided.

In one example implementation, an apparatus is provided that has management circuitry configured to cause a migration of a virtual machine from a source processing platform to a destination processing platform, so that a future execution of program instructions associated with the virtual machine are executed by destination processing circuitry of the destination processing platform instead of source processing circuitry of the source processing platform. The management circuitry is configured to cause the migration by causing a number of data pages belonging to the virtual machine to be migrated from a source memory device of the source processing platform to a destination memory device of the destination processing platform.

A virtual machine (VM) can be considered to be a type of execution environment in which applications reside and execute. From the perspective of the applications, they may be executing on a physical machine having its own physical resources. In practice, the physical resources are a ‘virtual’ perspective of a party of the physical system on which the virtual machine resides. Typically, virtual machines are managed by a hypervisor or other supervisory software that arbitrates the physical resources between the virtual machines and acts as a ‘go-between’ between the virtual machines and the physical machines. In one example implementation, the management circuitry referred to above may take the form of such hypervisor or supervisory software executing on a processing element, and may also be referred to herein as a virtual machine manager (VMM).

In accordance with the techniques described herein the apparatus also comprises integrity checking circuitry configured to check integrity of the virtual machine during the migration, and tracking storage used to maintain tracking information indicative of progress of the migration. The tracking information can take a variety of forms, but in accordance with one example implementation discussed in more detail later herein the tracking information may comprise a number of counters whose values are used by the integrity checking circuitry when assessing the integrity of the virtual machine. In some example implementations, the tracking information can also include other information, for example data page status information identifying, for each data page, a migration status of that data page.

The management circuitry is configured to employ a plurality of migration streams to perform the migration, which enables the use of multithreading when performing the migration in order to improve performance. In particular, in one example implementation, a processing thread can be allocated to each migration stream. In accordance with the techniques described herein, each migration stream is allocated an associated memory region that is mutually exclusive to a memory region allocated to any other migration stream in the plurality of migration streams, and each migration stream is used to migrate data pages within its associated memory region.

Further, the integrity checking circuitry is configured to use the tracking information to assess whether a set of integrity checking rules are satisfied, and to prevent the migration proceeding to a phase where program instructions of the virtual machine are permitted to be executed by the destination processing circuitry unless the set of integrity checking rules are satisfied. The set of integrity checking rules are determined taking into account that any given data page is constrained to be migrated using the migration stream whose associated memory region contains the given data page. In particular, it has been found that by virtue of this constraint on how any given data page is migrated, the amount of tracking information that needs to be maintained for use by the integrity checking circuitry can be significantly reduced, and the set of integrity checking rules to be assessed can be simplified, relative to an implementation that allows any of the migration streams to migrate any of the data pages. As a result, this can significantly reduce the cost and complexity of implementing integrity checking in relation to the virtual machine being migrated.

There are various triggers that could be used to cause the integrity checking circuitry to assess whether the set of integrity checking rules are satisfied. However, in one example implementation, the management circuitry may decide that it has reached a stage in the live migration where it wants to transition execution of the virtual machine from the source processing circuitry to the destination processing circuitry, and at this point the integrity checking circuitry can be triggered to perform an assessment of whether the set of integrity checking rules are satisfied, and to only allow the transition to take place at that point in time if those set of integrity checking rules are satisfied.

Such an approach can yield significant benefits irrespective of the form of the virtual machine being migrated. However, the above described approach is particularly beneficial when the virtual machine being migrated is a confidential virtual machine. A confidential virtual machine (CVM) is a particular type of virtual machine in which the hypervisor (i.e. the management circuitry) may be treated as an untrusted entity. In particular, in such an implementation, despite the hypervisor allocating use of memory address space of the memory device to the CVM, the data pages provided within that memory address space of the memory device that are owned by a CVM are not readable (e.g. they are not accessible) to the hypervisor. This could be achieved by the parts of the memory device owned by the CVM being encrypted, or it could be enforced by the hypervisor being physically prevented from accessing parts of the memory device that belong to CVMs. The data pages are therefore off-limits or blocked.

In such an implementation where the virtual machine is a confidential virtual machine, and the management circuitry is prohibited from accessing the data pages of the confidential virtual machine, the apparatus may further comprise security circuitry configured to maintain security of the confidential virtual machine during the migration, and in such cases the earlier-mentioned integrity checking circuitry may be provided by the security circuitry. In such an implementation, the security circuitry is both responsible for the confidentiality of the content of the CVM, and the integrity of that CVM when it is migrated from the source processing platform to the destination processing platform. This can be contrasted with an implementation where the virtual machine being migrated is a non-confidential virtual machine, in which case the content of the virtual machine does not need to be kept confidential from the management circuitry and, if desired, the functionality of the integrity checking circuitry may be incorporated within the management circuitry, and hence be part of the VMM.

In one example implementation, the security circuitry is configured, for a selected data page that the management circuitry wishes to migrate, to generate a corresponding migration package for the selected data page in which the content of the selected data page is encrypted in order to inhibit access to content of the data page by the management circuitry, and which includes an indication of the migration stream whose associated memory region includes the selected data page. The management circuitry is then arranged to cause the selected data page to be migrated via transfer of the corresponding migration package to the destination processing platform for handling by destination security circuitry of the destination processing platform, wherein the destination security circuitry is employed to decrypt the content prior to storing the content of the data page to the destination memory device.

When the management circuitry wishes to migrate a particular data page, it may be arranged to send a request to the security circuitry in order to request that a corresponding migration package is created for that data page. Whilst in one example implementation that request may provide an indication of the migration stream that the request relates to, with the security circuitry then checking that that is the correct migration stream to use for the data page in question, in another example implementation, the request may merely identify the data page that the management circuitry wishes to migrate, and the security circuitry will generate the corresponding migration package and provide as part of the migration package an indication of the migration stream that will be used to migrate the data page. It should be noted that whilst in one example implementation an explicit indication of the migration stream may be provided within the migration package, in other implementations an explicit indication may not be required. In particular, the migration package will identify the address of the data page that that migration package relates to, and based on the address the migration stream can then be identified, since the memory region containing that address will only have been allocated to one migration stream.

The security circuitry can be implemented in a variety of ways, but in one example implementation is provided through the use of a trusted execution environment in association with the apparatus, such as may be achieved by using the Realm Management Extension (RME) developed by Arm Limited, Cambridge, United Kingdom. RME is the hardware component of the Arm Confidential Compute Architecture (Arm CCA) which also include software elements. RME dynamically transfers resources and memory to a new protected address space that higher privilege software cannot access. Due to this address space, Arm CCA constructs protected execution environments called realms. Realms allow a lower-privileged software, like an application or a virtual machine, to protect its content. Realms also prevent execution from attacks using software that runs at higher privilege levels, like an operating system or a hypervisor. Higher-privileged software is still responsible for allocating and managing the resources that a realm uses. However, this higher-privileged software cannot access the contents of the realm or affect its execution flow. Hence, in one example implementation a CVM can be established within a realm, and whilst the management circuitry (an example of higher-privileged software) may be responsible for allocating and managing the resources that the CVM uses, it cannot access the contents of the CVM. The CVM, and indeed any other realms established, may be managed by a realm manager. In one example implementation, the security circuitry referred to above may take the form of such a realm manager executing on a processing element, and may also be referred to herein as a realm management module (RMM).

When adopting such an implementation, it is desirable to keep the realm manager, and the resources it requires, as constrained as possible, as this can assist in ensuring the robustness and security of the realm manager. Hence, the benefits realised when utilising the techniques described herein, namely a reduction in the amount of tracking information that needs to be maintained, and a simplification of the integrity checking rules, can be particularly useful when the virtual machine being migrated is a CVM, since in such instances the integrity checking tasks, and the maintenance of the required tracking information, will be undertaken by the RMM.

In one example implementation, the migration packages can take a variety of forms. For example, some migration packages may contain the content of a data page associated with that migration package, whilst other migration packages may not contain such content (for example when a migration package is used to identify to the destination processing platform that a previously migrated data page should be invalidated on the destination processing platform due to the content of that data page having been altered on the source processing platform since that data page was previously migrated). In one such example implementation, when the corresponding migration package contains content of the selected data page, then as noted above the content is encrypted within the corresponding migration package to inhibit access to that content by the management circuitry, and the destination security circuitry is employed to decrypt the content prior to storing the content of the data page to the destination memory device. In particular, in one example implementation, security circuitry is provided on both the source processing platform and the destination processing platform, with the security circuitry on the source processing platform being responsible for the generation of migration packages, and the security circuitry on the destination processing platform being responsible for consuming migration packages (which for a migration package containing content of a data page, will involve the decryption of that content and the storing of that content into the memory device of the destination processing platform). In one example implementation it is only the content of the selected data page that is encrypted within a migration package, and other information included within the migration package, such as an indication of address and certain items of metadata, are not encrypted. Instead, a hash value may be included within the migration package that prevents manipulation of a migration package's contents by the management circuitry (any such manipulation would cause a hash check performed by the security circuitry to fail).

In one example implementation, the security circuitry is arranged to maintain the tracking information in the tracking storage. Hence, it is the security circuitry that is responsible for maintaining the information that it will in due course require in order to assess whether the set of integrity checking rules are satisfied, and in one example implementation the security circuitry will ensure that the tracking information cannot be accessed or tampered with by the management circuitry.

There are various ways in which the number of migration streams to be used may be determined. However, in one example implementation, the management circuitry is configured to choose the number of migration streams to be employed, up to a maximum number of migration streams supported by the security circuitry. Further, the security circuitry is configured to determine the associated memory region to be allocated to each migration stream in dependence on the number of migration streams chosen by the management circuitry. Hence, the security circuitry will be responsible for controlling how the memory space is allocated amongst the various migration streams. This hence enables the security circuitry to ensure the mutual exclusivity of the allocated memory regions, and in particular that no part of the memory space allocated to one migration stream is allocated to any other migration stream. In one example implementation the above steps are performed by management circuitry and security circuitry residing on the source processing platform.

There are various ways in which the memory regions can be constructed. However, in one example implementation, for each migration stream the associated memory region comprises multiple blocks of memory addresses. Hence, each memory region is formed of multiple discrete blocks of memory addresses.

How these various blocks of memory addresses are correlated with each other may vary dependent on implementation. However, in one example implementation, for each migration stream the blocks of memory addresses forming the associated memory region are interleaved with blocks of memory addresses forming the associated memory regions of each other migration stream. By the use of such an interleaving of the blocks of memory addresses, this can reduce the chance of a migration workload imbalance between the different migration streams.

The interleaving can take a variety of forms. However, in one particular example implementation, the plurality of migration streams comprise N migration streams, and for each migration stream the blocks of memory addresses forming the associated memory region are separated by a regular stride so as to comprise every Nth block within an area of memory containing the data pages belonging to the virtual machine, and each block of memory addresses is only allocated to one migration stream. This can provide a simple and effective mechanism for creating the mutually exclusive memory regions for each migration stream.

The size of each block may vary dependent on implementation. However, in one example implementation the size of a block is chosen taking into account a sizing factor employed in relation to address translation within the apparatus. In particular, in one example implementation, the program instructions of the virtual machine are configured to refer to virtual memory addresses, the virtual machine is configured to manage a stage 1 address translation used to translate a given virtual address into a given intermediate address, and the management circuitry is configured to at least partly manage a stage 2 address translation used to translate the given intermediate address into a given physical address. When considering a non-confidential virtual machine, the stage 2 address translation process may be managed solely by the management circuitry, but when considering a confidential virtual machine the management of the stage 2 address translation may be performed in combination by the management circuitry and the security circuitry.

The stage 2 address translation may comprise reference to a series of page tables ending in a leaf page table provided for an area of memory address space of a predetermined size X. In one such example implementation, each block of memory addresses forming the associated memory region of a given migration stream is of the predetermined size X. A benefit that can arise from such a sizing of the blocks of memory addresses forming each memory region is that it avoids different migration streams needing to access the same leaf nodes during stage 2 address translation, hence avoiding one migration stream from needing to wait on another migration stream, and thus enabling the various migration streams to be processed independently. To enable this benefit to be realised, in one example implementation the start addresses of the blocks are aligned with the start addresses of the areas of memory covered by each leaf page table so that any addresses with a given block will all end up at the same leaf page table during stage 2 address translation.

The tracking information maintained in the tracking storage for use by the integrity checking circuitry can take a variety of forms, dependent on implementation. However, in one example implementation, the tracking information comprises a plurality of counters maintained by the integrity checking circuitry. The integrity checking circuitry may then be configured to determine, at a given point in time, that the set of integrity checking rules are satisfied when the plurality of counters have values that guarantee that the integrity of the virtual machine will be met were the migration to proceed, at that given point in time, to the phase where program instructions of the virtual machine are permitted to be executed by the destination processing circuitry. The use of such counters can provide a compact form of tracking information that is sufficient to enable the security circuitry to assess whether the set of integrity checking rules are satisfied, and hence can lead to a particularly efficient implementation.

In one example implementation, the security circuitry may comprise components on both the source and destination processing platforms. In one such example implementation, the security circuitry on the source processing platform may be arranged to initiate the process of assessing whether the integrity checking rules are satisfied, but the security circuitry on the destination processing platform may also be used to perform one or more of the required checks.

In one example implementation, once the confidential virtual machine has been permitted to run on the destination platform, the security circuitry will no longer allow it to run on the source processing platform any more.

The above-mentioned counters can take a variety of forms, but in one example implementation one counter used is a dirty page counter. In particular, in such an example implementation, the integrity checking circuitry may be configured to maintain data page status information (which in one example implementation may be viewed as another form of tracking information maintained in the tracking storage, in addition to the earlier mentioned counters) identifying, for each data page belonging to the virtual machine, a migration status of that data page selected from a plurality of migration status indications. One of the migration status indications comprises a dirty status indication that, when set as the migration status for a given data page, indicates that the given data page has been migrated to the destination processing platform, but subsequently content of the given data page has been changed on the source processing platform. By then arranging for the integrity checking circuitry to maintain a dirty page counter, that counter can be used to record the number of data pages that are identified by the data page status information as having the dirty status indication. The integrity checking circuitry may then be configured to determine that the set of integrity checking rules are failed when the dirty counter identifies that one or more data pages have the dirty status indication. Such a check can hence be used to implement a “post-copy entry” restriction, which requires that in order to enter a phase of the migration where the virtual machine can be executed by the destination processing circuitry it is necessary for no dirty pages belonging to the virtual machine to exist on the source processing platform.

In one example implementation, the data pages are migrated via transfer of corresponding migration packages from the source processing platform to the destination processing platform. As noted earlier, when the virtual machine being migrated is a confidential virtual machine, such migration packages will be created by the security circuitry, and any data page content included within those migration packages will be encrypted to prevent access to that content by the management circuitry. In contrast, when the virtual machine being migrated is a non-confidential virtual machine, such migration packages may be created by the management circuitry itself, and the data page content will not be encrypted.

In one such example implementation, the plurality of counters maintained by the integrity checking circuitry comprise an inflight counter indication for each migration stream used to identify a number of the migration packages issued by that migration stream to the destination processing platform that have yet to be processed by the destination processing platform. Each migration package will relate to a particular data page, and may provide content for that data page (in encrypted form where a CVM is being migrated) or may identify a data page whose migrated contents are to be invalidated on the destination processing platform. The integrity checking circuitry may then be configured to determine that the set of integrity checking rules are failed when any of the inflight counter indications indicate that at least one issued migration package is still to be processed by the destination processing platform. Such a check can hence be used to implement a “packages consumption” restriction, which requires that in order to enter a phase of the migration where the virtual machine can be executed by the destination processing circuitry it is necessary for all migration packages created by the source processing platform to be consumed by the destination processing platform.

Further, in one example implementation, the plurality of counters maintained by the integrity checking circuitry comprise a source migration counter for each migration stream whose value is used to indicate how many migration packages have been issued by that migration stream to the destination processing platform. For each migration package issued to the destination processing platform by a given migration stream, an indication of the associated source migration counter value may be provided as metadata in that migration package. The destination processing platform may then be configured, for each migration stream, to use the source migration counter value indications provided as metadata in the migration packages to ensure that the migration packages are processed by the destination processing platform in a same order that they were issued by that migration stream. Further, the destination processing platform may be configured to maintain a destination migration counter for each migration stream whose value is used to indicate how many migration packages of that migration stream have been processed by the destination processing platform. The integrity checking circuitry may then be configured to determine that the set of integrity checking rules are failed when, for any given migration stream, the values of the destination migration counter and the source migration counter indicate a mismatch. Such a check can hence be used to implement both the earlier-mentioned packages consumption restriction, and additionally a “stream order” restriction which requires that in order to enter a phase of the migration where the virtual machine can be executed by the destination processing circuitry it is necessary for the migration packages within the same migration stream to be consumed by the destination processing platform in the same order that they were created by the source processing platform. Hence, in such an example implementation it can be seen that the earlier mentioned in-flight counter indication for each migration stream may be determined with reference to both the source and destination migration counters maintained for that migration stream.

In one example implementation, the integrity checking circuitry may comprise source integrity checking circuitry on the source processing platform and destination integrity checking circuitry on the destination processing platform that operate in combination to determine whether the set of integrity checking rules are satisfied. Further, the tracking storage may comprise source tracking storage to maintain tracking information used by the source integrity checking circuitry and destination tracking storage to maintain tracking information used by the destination integrity checking circuitry.

Whilst the integrity checking circuitry may be arranged to evaluate compliance with the set of integrity checking rules at various points in time, in one example implementation the integrity checking circuitry is configured to evaluate whether the set of integrity checking rules are satisfied in response to the management circuitry indicating a desire to transition to the phase where program instructions of the virtual machine are permitted to be executed by the destination processing circuitry, and to permit the transition if the set of integrity checking rules are satisfied. Hence, the integrity checking circuitry can act as a gatekeeper to ensure that transition to execution of the virtual machine on the destination processing circuitry will only occur if it determines that the set of integrity checking rules are satisfied.

As noted earlier, the use of multiple migration streams support the use of multithreading. In particular, the management circuitry may be configured to allocate a processing thread to each migration stream and, for a given migration stream, to employ the allocated processing thread to perform the migration of data pages within the associated memory region of that migration stream. Whilst each migration stream may be allocated a different processing thread in one example implementation, in another example implementation it may be the case that one processing thread is allocated more than one migration stream. Further, in one example implementation the allocation of a migration stream to a processing thread is not immutable, and migration streams may be reallocated between processing threads during the migration process if desired. However, irrespective of any such reallocations, throughout the migration process the relationship between any given migration stream and its associated memory region remains unchanged, i.e. once a memory region has been allocated to a migration stream, that association is immutable for the duration of the migration process.

Particular examples will now be described with reference to the figures.

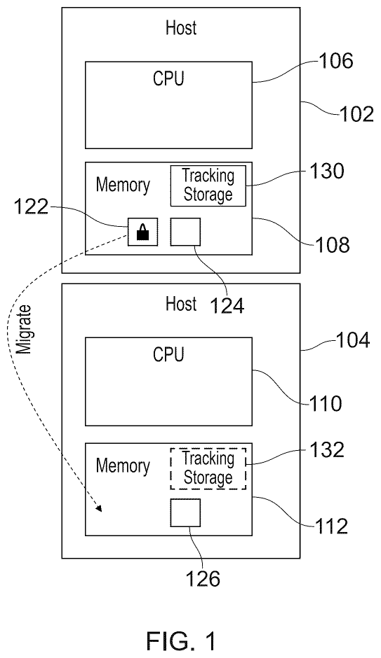

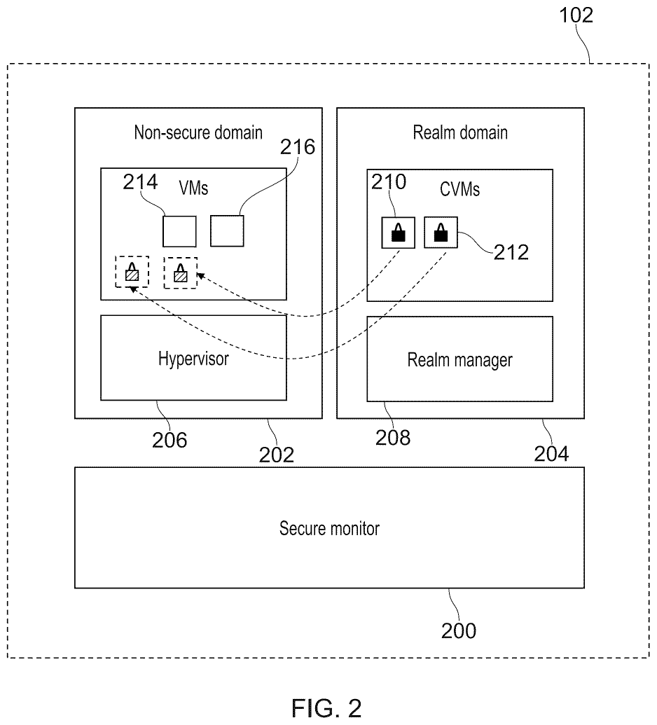

FIG. 1 illustrates a system in accordance with one example implementation. In this example, there are a number of virtual machines (VMs) 122, 124 that execute on a CPU 106 of a host 102. The VMs 122, 124 are resident within a memory 108 associated with the CPU 106. In this example, it is assumed that the virtual machine 122 is to be migrated so that it is executed on the CPU 110 of another host 104 having another memory 112 on which another virtual machine 126 is stored. Also in this example, the migrating virtual machine 122 is a confidential virtual machine so that the hypervisor (shown in FIG. 2), although ultimately responsible for scheduling the confidential virtual machine 122, is unable to access the memory belonging to that virtual machine 122. This lack of access may be through encryption or may be through physical access control.

In accordance with the techniques described herein, a live migration process is employed in order to migrate the virtual machine 122 from the source processing platform (the host 102) to the destination processing platform (the host 104). As discussed earlier, in accordance with a live migration process, at least some of the data pages of the virtual machine being migrated are migrated whilst the virtual machine is still running on the source processing platform, which reduces downtime of the virtual machine relative to a cold migration, but can increase complexity as the data pages may be altered after they have been migrated, and hence may need to be migrated more than once and/or copies of data pages may need to be invalidated within the memory 112 of the destination processing platform. In accordance with the techniques described herein, integrity checking circuitry is used to seek to ensure the integrity of the virtual machine during the migration process, and in particular to ensure that the migration process does not proceed to a phase where the virtual machine 122 is allowed to begin executing on the destination processing platform 104 unless a set of integrity checking rules are determined to be satisfied. In order to enable the integrity checking circuitry to evaluate whether the set of integrity checking rules are satisfied, tracking storage 130 (which may for example be implemented in a particular area of memory 108) is used on the source processing platform to maintain tracking information that is indicative of the progress of the migration. In one example implementation, there is also tracking storage 132 on the destination processing platform (for example within the memory 112 of the destination processing platform) in which further tracking information may be maintained for reference by the integrity checking circuitry.

As noted earlier, when performing live migration it is not a requirement that the entire migration happens live, and at some point during the process a period of cold migration may be implemented. In one particular example implementation there are three phases of live migration, namely:
1. Pre-Copy
The virtual machine to be migrated is running on the source processing platform while its contents are being transferred to the destination processing platform. Management circuitry (which in one example implementation takes the form of a virtual machine manager (VMM)/hypervisor) operating on the source processing platform is arranged to dictate the order in which the data pages contents are sent (or resent) to the destination processing platform.
2. Cold-Copy (also known as Stop-and-Copy)
During this phase the virtual machine does not run on either of the processing platforms. The management circuitry on the source processing platform continues to transfer the data pages of the virtual machine in order to subsequently enable the running of the virtual machine on the destination processing platform. As this phase is a “black-out” period for the virtual machine, the aim of any implementation is typically to limit the duration of this phase as much as possible.
3. Post-Copy
During this phase the virtual machine is running on the destination processing platform. The remaining data page content of the virtual machine can then be transferred to the destination processing platform, and such transfer may either be continuous until complete, or performed on demand.

Whilst the VMM operating on the source processing platform may in one example implementation be responsible for deciding when it is appropriate to transition between the above three phases, the earlier-mentioned integrity checking circuitry is used to ensure integrity of the virtual machine is maintained during live migration. In particular, in accordance with the techniques described herein, a set of integrity checking rules assessed by the integrity checking circuitry are intended to ensure that at the start of the post-copy phase, the virtual machine on the destination processing platform either contains the latest version of the content of any given data page, or does not have a copy of the content of that given data page at all, hence avoiding the possibility that the virtual machine on the destination processing platform could operate on stale/out of date data. Hence, when the VMM on the source processing platform wishes to transition to the post-copy phase, the integrity checking circuitry will assess whether the set of integrity checking rules are satisfied in order to ensure that the above requirement is met before it allows a transition to the post-copy phase to take place. As will be discussed in more detail herein, in accordance with the techniques described herein, a significant reduction in the amount of tracking information that needs to be maintained in order to enable the integrity checking circuitry to perform such an assessment can be achieved.

FIG. 2 shows an example of one of the hosts 102. In one example implementation, the other host may be organised in the same way. Notionally, there are a pair of execution environments/domains under which virtual machines execute. Although these different execution environments may involve a physical separation of hardware, they are generally used to describe the behaviour or way in which the virtual machines are treated.

In a non-secure domain 202, ordinary virtual machines 214, 216 execute under the supervision of the hypervisor 206. The hypervisor 206 is an example of the claimed management circuitry. Note that ‘non-secure’ is not intended to be interpreted as ‘insecure’, but rather that the domain 202 is not a so called ‘secure domain’, which may be reserved for, for instance, the manufacturer of the hardware to use. Each of the virtual machines 214, 216 is allocated a share of physical resources (such as the CPU 106 and memory 108) to use in executing that virtual machine. The virtual machines 214, 216 are generally unaware of each other-resources that are allocated to one virtual machine are not identified or addressable by other virtual machines and so the memory is segmented. The hypervisor 206, which is responsible for controlling the use of the physical resources, may be able to read the memory used by one of these virtual machines 214, 216.

In contrast, a realm domain 204 also exists. The realm domain 204 is an execution environment in which access to its virtual machines 210, 212, known as confidential virtual machines (CVMs), is prohibited to the hypervisor 206. That is, the hypervisor 206 is able to allocate resources such as memory 108 but thereafter is unable to see the contents of that memory, which may be used by the confidential virtual machines 210, 212. Consequently the realm domain may be used by software providers that do not trust supervisory software running on the device such as the hypervisor 206. Note that in this situation, the hypervisor 206 is unable to access the memory used by the confidential virtual machines 210, 212 but is still responsible for those virtual machines 210, 212. It is not only aware of their existence, but is able to allocate resources, schedule the confidential virtual machines 210, 212, stop them, start them, and so on. The CVMs 210, 212 are also managed by a realm manager 208, which may be jointly responsible for creating the CVMs 210, 212, registering them, and so on. The realm manager is able to read the memory used by each of the CVMs 210, 212. The realm manager 208 is an example of the claimed security circuitry. In one such example implementation, the earlier discussed integrity checking circuitry may also be implemented by the realm manager, and hence the integrity checking circuitry can in that example implementation be considered to be part of the security circuitry. A secure monitor 200 is also provided. The secure monitor may run at the highest level of privilege on the device and is responsible for controlling the privilege level.

An example of a technology that can be used to implement realm domains such as those discussed with reference to FIG. 2 is the earlier discussed Realm Management Extension (RME) developed by Arm Limited, Cambridge, United Kingdom. For a more detailed explanation of realms, the reader is referred to commonly owned U.S. Pat. No. 12,147,355, the entire contents of which are hereby incorporated by reference.

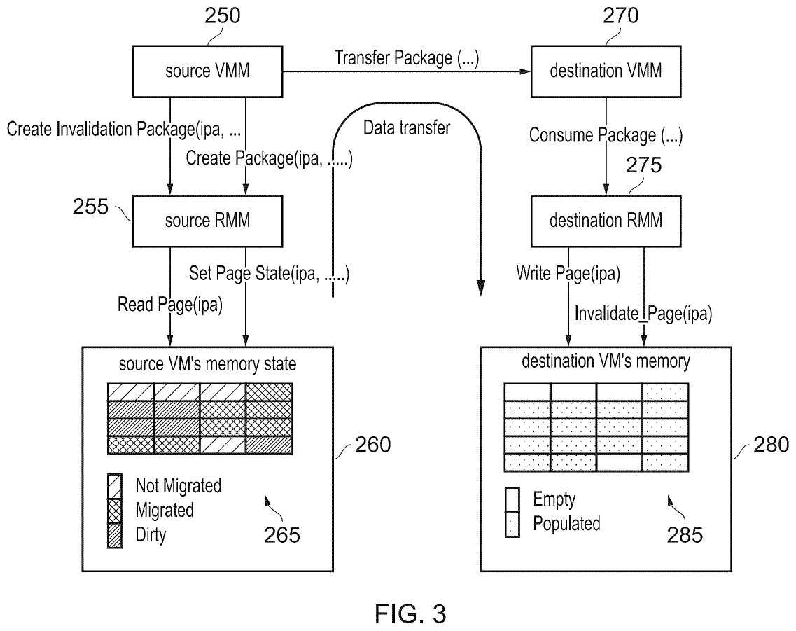

FIG. 3 schematically illustrates the process of live migration in an implementation where the virtual machine being migrated is a confidential virtual machine (CVM), in accordance with one example implementation. In this example, the earlier-mentioned management circuitry is implemented by hypervisor software providing virtual machine managers (VMMs) on both the source processing platform and the destination processing platform, and hence as shown there is a source VMM 250 on the source processing platform that during live migration is arranged to transfer migration packages to the destination VMM 270 on the destination processing platform.

Since the virtual machine being migrated is a CVM, it is the case that whilst the VMMs are still in charge of live migration, they are not to be trusted, and instead security circuitry is provided to maintain the confidentiality and integrity of the CVM during migration. In this example implementation, the security circuitry is provided by realm management modules (RMMs), also referred to herein as realm managers, operating on both the source and destination processing platforms, and hence as shown a source RMM 255 is provided on the source processing platform and a destination RMM 275 is provided on the destination processing platform. As will be discussed in more detail herein, the source and destination RMMs implement the functionality of the earlier discussed integrity checking circuitry, and hence can be arranged to assess whether a set of integrity checking rules are satisfied prior to allowing live migration to proceed to the post-copy phase.

In addition, the RMMs 255, 275 are used to ensure the confidentiality of the CVM's contents. Hence, when the source VMM 250 wishes to migrate a selected data page of the CVM to the destination processing platform, it sends a request to the source RMM 255 asking it to create a migration package for that data page. The migration package will identify the data page in question, incorporate the contents of that data page in an encrypted form so as to inhibit access to that content by the VMMs, and will incorporate certain metadata as will be discussed in more detail later. When the destination VMM 270 subsequently receives a migration package sent from the source VMM 250, it will send a request to the destination RMM 275 to cause that received migration package to be consumed. For the above type of migration package that contains the content of the data page, this will involve the decoding of that content, and the storing of that content into the destination VM's memory 280.

As noted earlier, during live migration, and in particular during the pre-copy phase where the CVM is still running on the source processing platform, it is possible that the content of a data page that has been migrated subsequently becomes dirty (i.e. is updated), and in that case action needs to be taken to update the copy held on the destination processing platform. This can be done by creating a further migration package for the data page in question, providing the updated contents. Alternatively, prior to performing such an update, the previous contents may merely be invalidated via the transmission of an invalidation migration package identifying the data page in question. Hence, the source VMM 250 can in that case request that the source RMM 255 creates an invalidation migration package for a specified data page, and once that migration package has been generated it can be transmitted to the destination VMM 270 for forwarding onto the destination RMM 275 where that migration package will be consumed. For such an invalidation migration package, the destination RMM 275 will determine the page being identified, and will invalidate the contents of that page within the destination VM's memory 280.

As shown in FIG. 3, within the source VM's memory 260, data page status information 265 identifying the state of each data page of the CVM being migrated can be maintained. In particular, for each data page, this data page status information can identify whether the data page has not yet been migrated, has been migrated, or is dirty (this latter state indicating that the content of that data page has been sent to the destination platform, but since that time the content has been changed on the source processing platform). In the described implementation, no such data page status information is maintained on the destination processing platform, and instead the relevant page sized chunks of memory 285 within the destination VM's memory 280 are either populated or empty, dependent on whether the contents of the corresponding data pages have been migrated or not. Whilst in one example implementation the source RMM 255 maintains the data page status information 265, the source RMM may inform the source VMM 250 of relevant changes in states, for example to notify the source VMM 250 when a page has become dirty and hence needs to be invalidated on the destination processing platform, and/or resent.

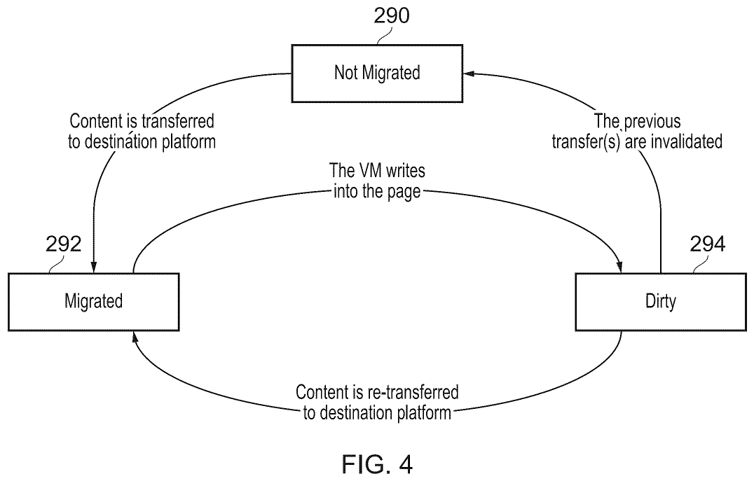

FIG. 4 is a state diagram illustrating how the migration status of any given data page may be transitioned between the three different migration states referred to earlier, in accordance with one example implementation. In particular, a data page in the not migrated state 290 will, when its content is transferred to the destination platform, transition to the migrated state 292. However, if the virtual machine whilst still running the source processing platform writes into that page, the state will change to the dirty state 294. To avoid the destination processing platform then having out of date content for the data page, an invalidation migration package may be created in order to invalidate the copy on the destination processing platform, creation of the invalidation migration package causing the state to transition back to the not migrated state 290. Subsequently, the data page contents may be resent by the generation of another migration package, causing the state to transfer back to the migrated state 292. As an alternative, rather than invalidating and then resending the content of the dirty data page, it is possible instead to merely create another migration package containing the updated contents and to transmit that migration package, causing the state to transition directly back from the dirty state 294 to the migrated state 292.

In order to improve performance, the source VMM 250 may create a number of migration streams that can be used to perform the live migration, and can allocate a processing thread to each migration stream. Similarly, the destination VMM 270 may allocate a processing thread to each migration stream. This stream-based approach hence allows a multithreaded implementation to be used, which can significantly improve performance. However, the use of such migration streams can significantly increase the complexity of performing integrity checks within the source and destination RMMs 255, 275 before allowing the live migration to proceed to the post-copy phase where the CVM is then allowed to be executed on the destination processing platform.

Prior to development of the technique described herein, one approach that could be taken would be to introduce the concept of a migration generation, also referred to herein as a migration epoch. The migration epoch is a period of time during live migration. The source RMM 255 can then be arranged to track the current migration epoch and to tag each migration package that it generates to indicate the migration epoch in place at the time that migration package was generated.

The RMMs 255, 275 could then preserve the integrity of the CVM by the following sequence of measures:
1) post-copy entry restriction: at the start of the post-copy phase, no dirty pages may exist on the source processing platform;
2) packages consumption restriction: at the start of the post-copy phase, all migration packages created by the source RMM 255 must be consumed by the destination RMM 275;
3) stream order restriction: the migration packages within the same migration stream must be consumed by the destination RMM 275 in the order in which they are created by the source RMM 255;
4) epoch restriction: within one migration epoch, only one migration package can be created for each data page of the CVM, which avoids the potential for stale data being introduced on the destination processing platform due to a same data page been migrated by different migration streams;
5) epoch order restriction: the migration packages must be consumed in the order of their migration epoch, e.g. any migration packages relating to epoch 1 must be consumed before any migration packages relating to epoch 2. This, in combination with the epoch restriction, can be used to ensure that stale data cannot be introduced on the destination processing platform due to the same data page been migrated by different migration streams.

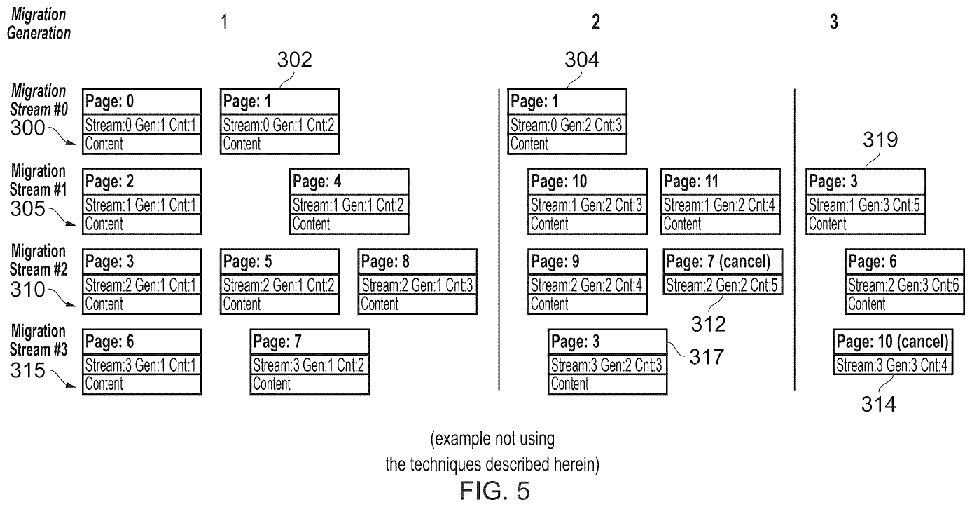

When adopting such an approach, the source RMM 255 will be arranged, for each migration package generated, to include metadata within that migration package that identifies the stream, the epoch/generation, and a count value used to maintain ordering of migration packages within each migration stream. An illustrative example of the migration packages that might be generated when adopting such an approach is shown in FIG. 5.

The source VMM 250 may decide when it wishes to change the epoch, and may for example do this when it determines that it wishes to send a migration package for a particular page that has already had a migration package sent for it in the current epoch (as noted above, a new epoch needs to be created at this point in order to ensure the above-mentioned epoch restriction is satisfied). Hence, this is why the migration generation/epoch is changed from epoch 1 to epoch 2 prior to creation/transmission of the migration package 304, since migration package 304 relates to page 1 and a previous migration package 302 for page 1 has already been generated in epoch 1. The migration package 304 may for instance be generated in order to retransmit the content of page 1, due for example to page 1 having become dirty.

For a similar reason, the migration epoch may transition to epoch 3 prior to the transmission of the migration package 319 for page 3 since a migration package 317 for page 3 has already been issued during migration epoch 2. Whilst most of the migration packages shown in FIG. 5 are packages that contain content of a page, as noted earlier it is possible to also create invalidation packages (such as packages 312, 314 shown in FIG. 5), which include the same metadata as the other packages, but do not provide any content, since the destination RMM 275 will consume those packages by identifying the page in question, and then invalidating the contents of that page as stored in the destination VM's memory 280.

Whilst such an approach can ensure the integrity of the CVM during live migration, it has a number of disadvantages. In particular, a large amount of tracking state needs to be maintained by the RMMs in order to ensure that the RMMs can assess whether the above-mentioned five restrictions are complied with prior to allowing live migration to proceed to the post-copy phase. Particularly problematic in this respect is the above-mentioned epoch restriction that requires that during any given epoch, only one migration package is created for each page. Significant state needs to be maintained by the source and/or destination RMMs in order to evaluate this restriction, and in particular some state needs to be maintained on a per page basis. For example, a flag could be maintained per page which is set when a migration package is created for that page and is cleared at the start of a new epoch. Alternatively, an epoch tag could be provided per page the records the last epoch in which a migration package is created for that page. There is significant cost and complexity associated with maintaining such detailed tracking information, and it would hence be beneficial to reduce the amount of tracking information that needs to be maintained in order to ensure integrity of a migrated virtual machine. This issue is of particular significance in association with the migration of CVMs, since it is desirable to keep the RMMs, and the resources they require, as constrained as possible, as this can assist in ensuring the robustness and security of the RMMs.

In addition to the above-mentioned disadvantage associated with the relatively large amount of tracking state that needs to be maintained, there are also other disadvantages that may arise. For example, as is clearly illustrated in FIG. 5, the migration streams on the destination platform must wait for each other at the end of each migration epoch. This is to ensure the epoch order restriction is satisfied, but can impact performance. Another potential issue that can arise when adopting the above described technique is that, due to the fact that each migration stream may be used to migrate an arbitrary page of the virtual machine, different migration streams may experience a lock contention within the RMMs on both the source and destination platforms. It should be noted that the RMMs will serialise accesses to VM pages that are referred to from the same leaf page table of stage 2 address translation.

In accordance with the techniques described herein, a significant reduction in the amount of tracking information that needs to be maintained, and a simplification of the integrity checking rules, relative to the approach discussed above with reference to FIG. 5, can be achieved by placing a specific restriction on the data pages that can be migrated by each migration stream. In particular, it will be appreciated from the above discussion with reference to FIG. 5 that any migration stream can generate a migration package for any data page, provided the above five restrictions are complied with. However, the inventors of the present technique have realised that by placing a restriction on which migration streams can be used to migrate which data pages, this can result in a significant simplification of the integrity checking rules, and a significant reduction in the amount of tracking state information that needs to be maintained in order to assess those integrity checking rules. The techniques described herein can also alleviate the other concerns mentioned above, by avoiding the need to synchronise migration streams at the end of an epoch (indeed the concept of epochs is removed), and by alleviating the lock contention issue.

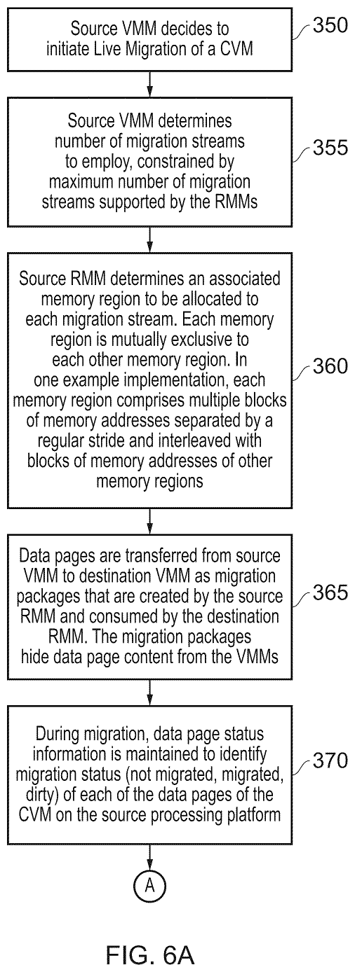

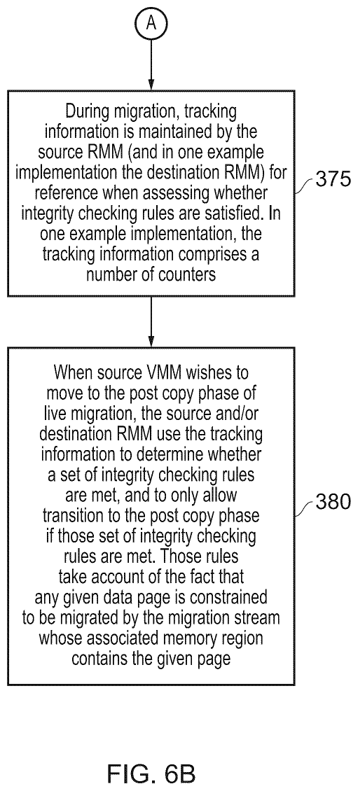

FIGS. 6A and 6B provide a flow diagram illustrating steps taken during the migration of a CVM, in accordance with one example implementation. At step 350, the source VMM 250 decides to initiate a live migration of a CVM. At step 355, the source VMM determines the number of migration streams to employ. In one example implementation, this is constrained by a maximum number of migration streams that are supported by the RMMs 255, 275. In particular, the RMMs may determine this dependent on a variety of factors, such as the number of physical processing elements provided on each platform to perform multithreading, the amount of resources that the RMMs have for maintaining tracking information for the migration streams which may affect the maximum number of streams for which the RMMs may maintain the required tracking information, etc.

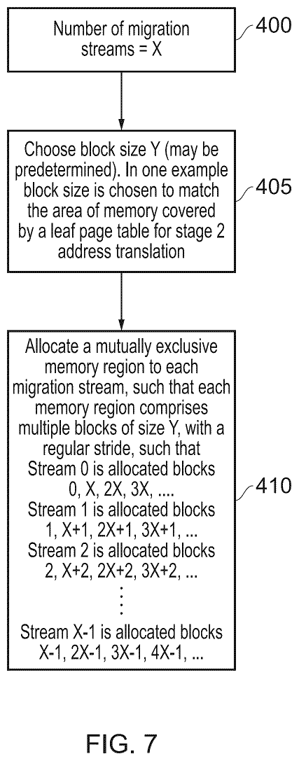

Once the source VMM 250 has determined the number of migration streams, then at step 360 the source RMM 255 is arranged to determine an associated memory region to be allocated to each migration stream. In particular, each allocated memory region is mutually exclusive to each other memory region, and hence each of the individual migration streams will have mutually exclusive memory regions allocated to them. Each migration stream is then responsible for migrating data pages within its associated memory region. As a result, for any given data page, there is only one migration stream that is responsible for migrating that data page. The memory regions can be organised in a variety of ways, but in one example implementation, as will be discussed in more detail later with reference to FIG. 7, each memory region comprises multiple blocks of memory addresses separated by a regular stride, and those multiple blocks are interleaved with blocks of memory addresses of other memory regions. This can be beneficial in supporting load balancing amongst the various migration streams.

At step 365, data pages of the CVM are transferred from the source VMM 250 to the destination VMM 270 via migration packages that are created by the source RMM 255 (hiding content of the data pages from the VMMs), and that are consumed by the destination RMM 275, as discussed earlier. As also discussed earlier, at step 370, during the migration process, data page status information is maintained by the source RMM 255 to identify the migration status (i.e. not migrated, migrated dirty) of each of the data pages of the CVM on the source processing platform.

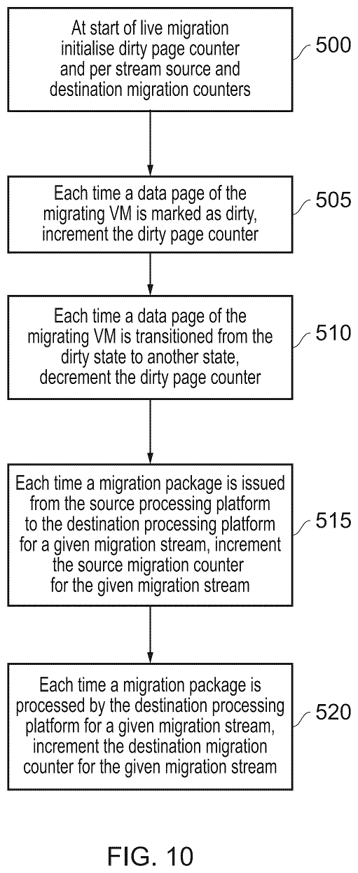

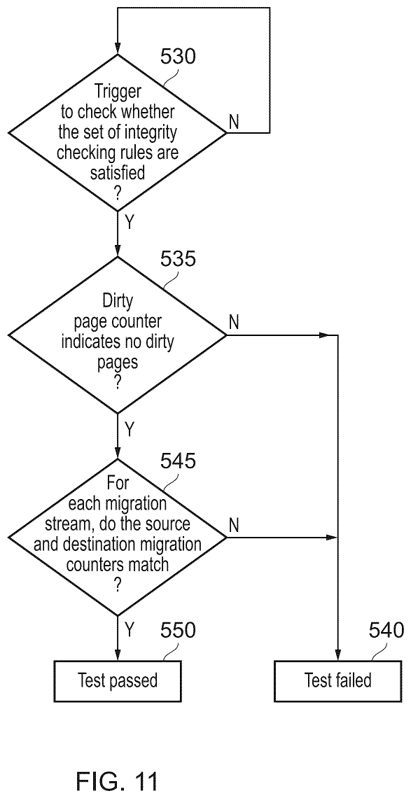

In addition, as indicated at step 375, during migration tracking information is maintained by the source RMM 255 for reference when assessing whether the integrity checking rules are satisfied. In the particular implementation described herein, additional tracking information is also maintained by the destination RMM 275, and checks are performed by both the source RMM and the destination RMM in order to determine whether the integrity checking rules are satisfied. The tracking information can take a variety of forms, but in one example information comprises a number of counters, as will be discussed in more detail later with reference to FIGS. 10 and 11.

As indicated by step 380, when the source VMM 255 decides that it wishes to move to the post-copy phase of live migration, the source RMM (in one example implementation in combination with the destination RMM) uses the tracking information to determine whether a set of integrity checking rules are met, and only allows transition to the post-copy phase if those set of integrity checking rules are met. Those rules take account of the fact that any given data page is constrained to be migrated by the migration stream whose associated memory region contains the given page. In particular, by adopting such a constraint, there is no longer any need to maintain and track separate migration epochs, since for any given data page that data page can only be migrated by one migration stream, and if a count indication is used to identify the order in which migration packages are created by each migration stream, it can be ensured that the migration packages of any given migration stream are consumed in the same order that they were created. Thus it is possible to avoid the potential for stale data being present on the destination processing platform at the time the post-copy phase is entered by merely checking that the restrictions 1 to 3 mentioned earlier are met prior to entering the post-copy phase, namely the post-copy entry restriction, the packages consumption restriction and the stream order restriction. Furthermore, it has been found that the tracking information required in order to assess whether those three restrictions are satisfied is quite minimal, and indeed in one example implementation may take the form of a relatively small number of counters, as will be discussed in more detail later with reference to FIGS. 10 and 11.

FIG. 7 is a flow diagram illustrating how mutually exclusive memory regions are allocated to each memory stream, in accordance with one example implementation. At step 400, the number of migration streams is determined, and for the purposes of FIG. 7 this number will be referred to as the value X. As noted earlier, in one example implementation the source VMM 250 is able to choose the number of migration streams, constrained by a maximum number that the RMMs 255, 275 will support. At step 405, a block size Y is chosen, and in one example implementation this parameter is controlled by the source RMM 255. This value could be configurable, or predetermined. In one example implementation the value Y is predetermined taking into account a particular sizing parameter used when implementing address translation. In particular, in one example implementation the block size is chosen to match the area of memory covered by a leaf page table used during stage 2 address translation. A brief description of address translation now follows in order to illustrate the leaf page table used during stage 2 address translation.

The software executing on the system may specify virtual addresses, and the mappings between virtual addresses and physical addresses may be stored in translation tables (also referred to herein as page tables). Translation tables are stored in memory and are managed by software, typically an OS or hypervisor. The translation tables are not static, and the tables can be updated as the needs of software change. This changes the mapping between virtual and physical addresses. The translation tables can also specify access control attributes such as information on whether a memory region can be accessed by read accesses, write accesses and instruction fetch accesses (for fetching an executable instruction) respectively.

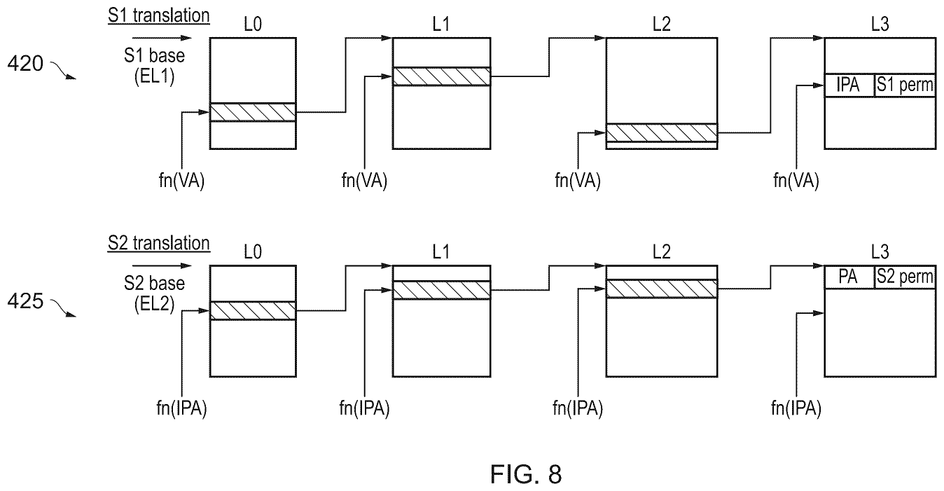

As illustrated schematically in FIG. 8, in one example implementation, a two-stage address translation may be used, which supports virtualization and allows a hypervisor (in combination with the realm manager for CVMs) to virtualize the view of physical memory that is seen by a given virtual machine (VM) (the virtual machine corresponding to a guest operating system and the applications controlled by that guest operating system). We call the set of translations that are controlled by the OS, Stage 1 420. The Stage 1 tables translate virtual addresses (VAs) to intermediate physical addresses (IPAs). In Stage 1, the OS thinks that the IPAs are physical addresses. However, the hypervisor/realm manager controls a second set of translation mappings, which is called Stage 2 425. This second set of translation mappings translates IPAs to physical addresses (PAs).

The stage-1 and stage-2 translation tables are implemented as hierarchical multi-level table structures comprising a number of levels of translation tables as shown in FIG. 8. In this example, both the stage-1 and stage-2 tables can have up to 4 levels of page tables, namely level 0(L0 ), level 1 (L1), level 2 (L2) and level 3 (L3).

To locate the physical address mapping for a given address, a translation table walk is performed comprising one or more translation table lookups. The translation table walk is the set of lookups (memory accesses) that are required to translate the virtual address to the physical address.

For traversing a given one of the stage-1 and stage-2 structures, the walk starts with a read of a top-level (L0) translation table for the initial lookup, based on an address specified in a translation table base address register (e.g. TTBR for stage 1, VTTBR_EL2 for stage 2). FIG. 8 illustrates indexing of the stage-1 and stage-2 translation tables using index values derived as a function of bits of the VA (for stage-1) or IPA (for stage-2). The particular entry to select within a given level of translation table is determined based on an index value which corresponds to, or is derived from, a certain subset of bits of the VA or IPA provided as input address for the lookup. Each level is indexed based on a different subset of bits of the VA or IPA, with a given level being indexed based on a more significant portion of bits of the VA/IPA than the next level in the structure (e.g. L2 is indexed using a less significant portion of bits than L1). The address of the relevant entry in a given table is obtained by adding a multiple of the index bits to the base address of that given table as determined based on TTBR or the address specified in a Table descriptor at the previous level (the multiplier applied to the index value corresponding to the size of one translation table entry). Once the page table walk process is complete, by performance of the stage 1 and stage 2 lookups, the information returned includes the required physical address, along with access permissions and or memory attributes for the addressed memory region which provide information about how to control access to that memory region. As illustrated in FIG. 8, these may include stage 1 access permissions and attributes defined in the stage 1 table structure and stage 2 access permissions and/or attributes defined in stage 2 table structure.

Considering FIG. 8, the final L3 level of the stage 2 translation 425 is an example of the earlier-mentioned leaf page table used during stage 2 address translation. Returning to FIG. 7, by choosing the block size Y to match the area of memory covered by a leaf page table for stage 2 address translation, and then allocating the blocks amongst the various migration streams in the manner illustrated at step 410 of FIG. 7 (discussed in more detail below), this means that any particular leaf page table used during stage 2 address translation will only be accessed for 1 migration stream, thus removing the earlier-mentioned lock contention issue.

As illustrated at step 410 of FIG. 7, a mutually exclusive memory region is allocated to each migration stream such that each migration stream comprises multiple blocks of size Y, with a regular stride. As a result, the blocks allocated for particular streams are those as illustrated in step 410 of FIG. 7. As will be apparent, for any given block, that block is only allocated to one of the migration streams. Each migration stream is then responsible for migration of any data pages residing within the blocks allocated to it.

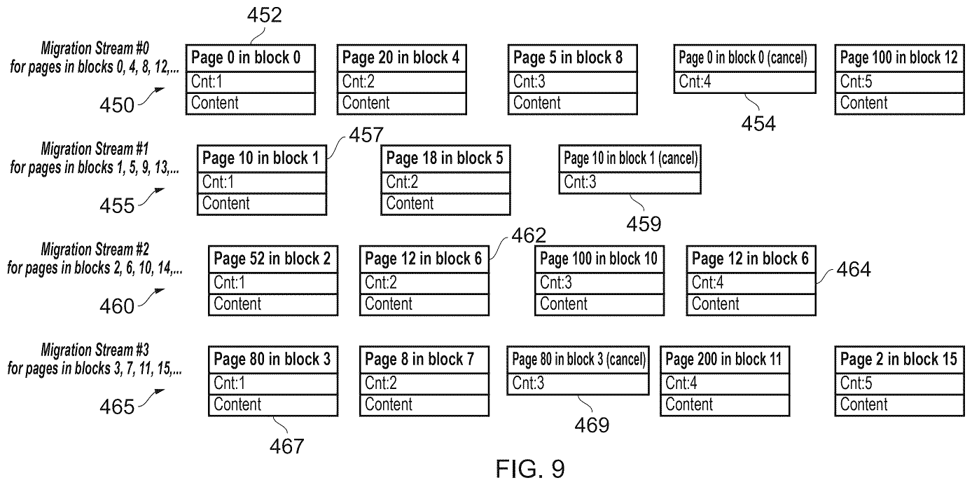

FIG. 9 is a diagram schematically illustrating the creation of migration packages during the pre-copy phase of live migration, in accordance with one example implementation, where each migration stream is allocated a series of blocks using the techniques described above with reference to FIG. 7. In accordance with this example, it is assumed that the page size is 4 KB, and the block size is 2 MB, and accordingly there are 512 pages in each block. For any given block, one migration stream is responsible for migrating the data pages in that block.

From a comparison of FIG. 9 with FIG. 5, it will be appreciated that there is no concept of different epochs, and accordingly no need to provide epoch/generation metadata in each migration package. As shown, the metadata for each migration package does include a count value, to enable the migration packages for any given migration stream to be consumed on the destination processing platform in the same order that they were created for that migration stream on the source processing platform. Other metadata that is included within each migration package in accordance with one example implementation, but omitted for simplicity in FIG. 9, comprises a package type indication (to distinguish between a migration package containing page content and a migration package specifying invalidation of a page), an address indication (which due to the fact that the migration is handled by the hypervisor/VMM may be specified as an intermediate physical address (IPA)), and a hash value used to check that the migration package has not been altered since it was generated. In addition to the indicated count value, a stream identifier could also be provided if desired, in the same way as illustrated earlier in the example of FIG. 5. However, in one example implementation, an explicit stream identifier is not provided as metadata, since the migration stream for any given migration package can be inferred from the address identifier provided for that migration package, due to the fact that each migration stream is allocated a mutually exclusive memory region.

As illustrated by way of specific example in FIG. 9, if a given page migrated by a given migration stream is later updated, an invalidation migration package can be issued by the same given migration stream to invalidate the content of that given page. Three examples of this are given in FIG. 9, the first example being where the migration package 452 that provides the content for page 0 in block 0 is later followed by an invalidation migration package 454 to invalidate the contents stored on the destination processing platform for page 0 in block 0. The second example is where the migration package 457 that provides the content for page 10 in block 1 is later followed by an invalidation migration package 459 to invalidate the contents stored on the destination processing platform for page 10 in block 1, and the third example is where the migration package 467 that provides the content for page 80 in block 3 is later followed by an invalidation migration package 469 to invalidate the contents stored on the destination processing platform for page 80 in block 3. Alternatively, when a previously migrated page is updated, a subsequent migration package for the same page can be issued by the same migration stream, without needing to first invalidate the page, if desired. An example of this is also given in FIG. 9, where a first migration package 462 for page 12 in block 6 is followed by a second migration package 464 for page 12 in block 6. As will be apparent from FIG. 9, since the migration of any given data page is always handled by the same migration stream, the provision of a count value in association with each migration package is sufficient to ensure that multiple migration packages relating to the same page are processed on the destination processing platform in the same order that they were created on the source processing platform.

FIG. 10 is a flow diagram illustrating how various counters provided as tracking information are updated during the live migration process, in accordance with one example implementation. At step 500, at the start of live migration, a dirty page counter is initialised, and per stream source and destination migration counters are also initialised. In one example implementation, the dirty page counter, along with the per stream source migration counters, are managed by the source RMM 255, whilst the per stream destination migration counters are managed by the destination RMM 275.

At step 505, each time a data page of the migrating VM is marked as dirty, the dirty page counter is incremented by the source RMM. Similarly, at step 510, each time a data page of the migrating VM is transitioned from the dirty state to another state, the dirty page counter is decremented.

As indicated by step 515, each time a migration package is issued from the source processing platform to the destination processing platform for a given migration stream, the source migration counter for the given migration stream is incremented by the source RMM 255. Similarly, at step 520, each time a migration package is processed by the destination processing platform for a given migration stream, the destination migration counter for the given migration stream is incremented by the destination RMM 275.

FIG. 11 is a flow diagram illustrating how the various counters maintained using the process of FIG. 10 are used by the integrity checking circuitry (provided by the RMMs when migrating a CVM) to assess whether the required set of integrity checking rules are satisfied. At step 530, a trigger is awaited that causes a check to be performed to determine whether the set of integrity checking rules are satisfied. This trigger may take a variety of forms, but in one example implementation may occur when the source VMM 250 decides that it wishes to transition the live migration to the post-copy phase.

Once this trigger occurs, then at step 535 it is determined whether the dirty page counter indicates that there are no dirty pages. This can be assessed by the source RMM 255 with reference to the earlier-mentioned dirty page counter. In particular, if the counter is zero, it can be determined that there are no dirty pages, and accordingly the earlier mentioned post-copy entry restriction has been met. Hence, if the dirty page counter indicates that there are one or more dirty pages, that restriction is determined not to have been met, and the test is determined to have failed at step 540. Hence, at this point, the source RMM will prevent transition of the live migration process to the post-copy phase.

However, if analysis of the dirty page counter reveals that there are no dirty pages, then the process proceeds to step 545 where it is determined, for each migration stream, whether the source and destination migration counters match. There are various ways in which this check can be performed, using information passed between the source RMM and the destination RMM. However, in one specific example implementation, if the post-copy entry restriction is determined to have been passed at step 535, the source RMM may (on the source VMM's request) generate a cryptographically protected “token” that must be consumed by the destination RMM to enable the running of the CVM on the destination platform. Once that token is generated, the source RMM may then prevent the CVM from running on the source platform (the RMMs ultimately being responsible for control of the execution of the CVM, and in particular which processing platform it is executed on).

The token can be arranged to also indicate the number of generated migration packages, and in particular may provide the source migration counter values for each migration stream. By comparing this information with the corresponding destination migration counter values maintained by the destination RMM 275, the destination RMM can hence evaluate whether the condition of step 545 is met. In particular, if the counter values match, this will mean that both the packages consumption restriction, requiring all migration packages created by the source RMM to be consumed by the destination RMM, and the stream order restriction requiring that migration packages within the same migration stream are consumed by the destination RMM in the order in which they created by the source RMM, have been met. Accordingly, if the check at step 545 is passed, then all three of the required restrictions will be determined to be in place, and hence it will be determined the integrity checking rules are satisfied, and the process can proceed to step 550 where the test is considered to have been passed. At this stage, the destination RMM may then allow the running of the CVM on the destination processing platform, hence causing live migration to transition to the post-copy phase. Conversely, if the check at step 545 is not passed, the process will proceed to step 540, where the test is considered to have failed and transition to the post-copy phase is prevented.

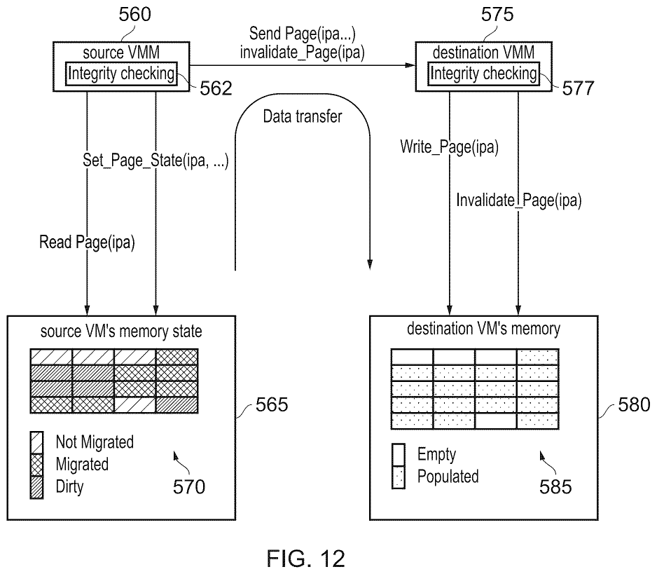

Whilst the above described example implementations have been discussed in the context of a CVM being migrated from a source processing platform to a destination processing platform, it should be noted that the same techniques could also be employed in association with migration of a non-confidential virtual machine. Such an approach is illustrated schematically in FIG. 12. Since the virtual machine is a non-confidential virtual machine, there will not be any RMMs involved, and the integrity checking circuitry can be considered to be implemented by the source VMM 560 and the destination VMM 575. Hence, the integrity checking functionality 562 provided on the source VMM 560 can be used to perform the integrity checking processes previously discussed as performed by the source RMM when migrating a confidential virtual machine, whilst the integrity checking functionality 577 provided on the destination VMM 575 can be used to perform the integrity checking processes previously discussed as performed by the destination RMM when migrating a confidential virtual machine. Hence, by way of example, the integrity checking functionality 562 will be responsible for maintaining the source VM's memory state 570 (the earlier described status information for each data page of the migrating VM) within the source VM's memory 565 and for maintaining the dirty page counter and the per stream source migration counters. Further, the integrity checking functionality 577 will be responsible for maintaining the per stream destination migration counters. As with the earlier example of FIG. 3, the destination processing platform does not need to maintain state information for each data page, and instead the relevant page sized chunks of memory 585 within the destination VM's memory 580 are either populated or empty, dependent on whether the contents of the corresponding data pages have been migrated or not.

Instead of requiring RMMs to generate and consume migration packages, when migrating a non-confidential virtual machine the source VMM will be arranged to generate migration packages, and the destination VMM will be arranged to consume those migration packages. The migration packages may still have a form similar to that illustrated with reference to FIG. 9, and hence for example may include the same metadata, but it should be noted that the content will not be encrypted, in contrast to the content of data pages transferred when migrating a confidential virtual machine.

It will be appreciated that when adopting the approach shown in FIG. 12, the techniques described earlier herein still enable a significant reduction in the amount of tracking information required to be maintained, and a simplification of the integrity checking rules, and hence can still provide significant benefits when used in association with the migration of non-confidential virtual machines.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

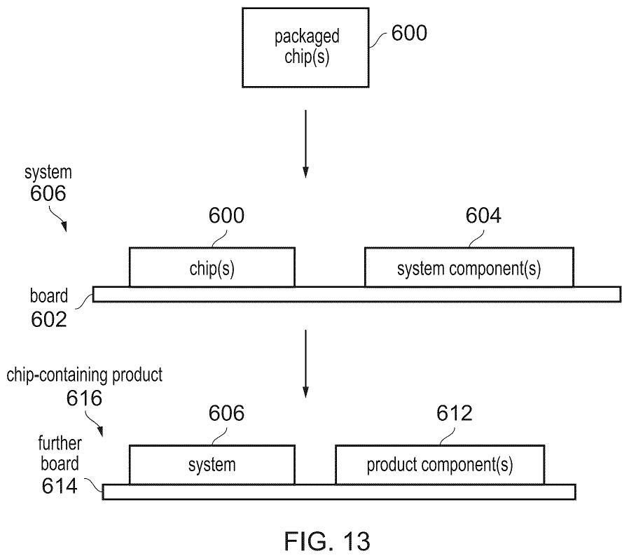

As shown in FIG. 13, one or more packaged chips 600, with the apparatus described above implemented on one chip or distributed over two or more of the chips, are manufactured by a semiconductor chip manufacturer. In some examples, the chip product 600 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 600 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips combined to provide the functionality of a single chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 600 are assembled on a board 602 together with at least one system component 604 to provide a system 606. For example, the board may comprise a printed circuit board. The board substrate may be made of any of a variety of materials, e.g. plastic, glass, ceramic, or a flexible substrate material such as paper, plastic or textile material. The at least one system component 604 comprise one or more external components which are not part of the one or more packaged chip(s) 600. For example, the at least one system component 604 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 616 is manufactured comprising the system 606 (including the board 602, the one or more chips 600 and the at least one system component 604) and one or more product components 612. The product components 612 comprise one or more further components which are not part of the system 606. As a non-exhaustive list of examples, the one or more product components 612 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 606 and one or more product components 612 may be assembled on to a further board 614.

The board 602 or the further board 614 may be provided on or within a device housing or other structural support (e.g. a frame or blade) to provide a product which can be handled by a user and/or is intended for operational use by a person or company.

The system 606 or the chip-containing product 616 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Some example configurations are set out in the following numbered clauses:

1. An apparatus comprising:
management circuitry configured to cause a migration of a virtual machine from a source processing platform to a destination processing platform, so that a future execution of program instructions associated with the virtual machine are executed by destination processing circuitry of the destination processing platform instead of source processing circuitry of the source processing platform, wherein the management circuitry is configured to cause the migration by causing a number of data pages belonging to the virtual machine to be migrated from a source memory device of the source processing platform to a destination memory device of the destination processing platform;
integrity checking circuitry configured to check integrity of the virtual machine during the migration; and
tracking storage used to maintain tracking information indicative of progress of the migration;
wherein:
the management circuitry is configured to employ a plurality of migration streams to perform the migration, where each migration stream is allocated an associated memory region that is mutually exclusive to a memory region allocated to any other migration stream in the plurality of migration streams, and each migration stream is used to migrate data pages within its associated memory region; and
the integrity checking circuitry is configured to use the tracking information to assess whether a set of integrity checking rules are satisfied, and to prevent the migration proceeding to a phase where program instructions of the virtual machine are permitted to be executed by the destination processing circuitry unless the set of integrity checking rules are satisfied, wherein the set of integrity checking rules are determined taking into account that any given data page is constrained to be migrated using the migration stream whose associated memory region contains the given data page.

2. An apparatus as in Clause 1, wherein:
the virtual machine is a confidential virtual machine, and the management circuitry is prohibited from accessing the data pages of the confidential virtual machine;
the apparatus further comprises security circuitry configured to maintain security of the confidential virtual machine during the migration, and the integrity checking circuitry is provided by the security circuitry;
the security circuitry is configured, for a selected data page that the management circuitry wishes to migrate, to generate a corresponding migration package for the selected data page in which content of the selected data page is encrypted in order to inhibit access to content of the selected data page by the management circuitry, and which includes an indication of the migration stream whose associated memory region includes the selected data page; and
the management circuitry is arranged to cause the selected data page to be migrated via transfer of the corresponding migration package to the destination processing platform for handling by destination security circuitry of the destination processing platform, wherein the destination security circuitry is employed to decrypt the content prior to storing the content of the data page to the destination memory device.

3. An apparatus as in Clause 2, wherein the security circuitry is arranged to maintain the tracking information in the tracking storage.

4. An apparatus as in Clause 2 or Clause 3, wherein the management circuitry is configured to choose the number of migration streams to be employed, up to a maximum number of migration streams supported by the security circuitry, and the security circuitry is configured to determine the associated memory region to be allocated to each migration stream in dependence on the number of migration streams chosen by the management circuitry.

5. An apparatus as in any preceding clause, wherein for each migration stream the associated memory region comprises multiple blocks of memory addresses.

6. An apparatus as in Clause 5, wherein for each migration stream the blocks of memory addresses forming the associated memory region are interleaved with blocks of memory addresses forming the associated memory regions of each other migration stream.

7. An apparatus as in Clause 6, wherein the plurality of migration streams comprise N migration streams, and for each migration stream the blocks of memory addresses forming the associated memory region are separated by a regular stride so as to comprise every Nth block within an area of memory containing the data pages belonging to the virtual machine, and each block of memory addresses is only allocated to one migration stream.

8. An apparatus as in any of clauses 5 to 7, wherein:
the program instructions of the virtual machine are configured to refer to virtual memory addresses, the virtual machine is configured to manage a stage 1 address translation used to translate a given virtual address into a given intermediate address, and the management circuitry is configured to at least partly manage a stage 2 address translation used to translate the given intermediate address into a given physical address;
the stage 2 address translation comprises reference to a series of page tables ending in a leaf page table provided for an area of memory address space of a predetermined size X; and
each block of memory addresses forming the associated memory region of a given migration stream is of the predetermined size X.

9. An apparatus as in any preceding clause, wherein:
the tracking information comprises a plurality of counters maintained by the integrity checking circuitry;
the integrity checking circuitry is configured to determine, at a given point in time, that the set of integrity checking rules are satisfied when the plurality of counters have values that guarantee that the integrity of the virtual machine will be met were the migration to proceed, at that given point in time, to the phase where program instructions of the virtual machine are permitted to be executed by the destination processing circuitry.

10. An apparatus as in Clause 9, wherein:
the integrity checking circuitry is configured to maintain data page status information identifying, for each data page belonging to the virtual machine, a migration status of that data page selected from a plurality of migration status indications;
one of the migration status indications comprises a dirty status indication that, when set as the migration status for a given data page, indicates that the given data page has been migrated to the destination processing platform, but subsequently content of the given data page has been changed on the source processing platform;
the plurality of counters maintained by the integrity checking circuitry comprises a dirty page counter whose value records the number of data pages that are identified by the data page status information as having the dirty status indication; and
the integrity checking circuitry is configured to determine that the set of integrity checking rules are failed when the dirty counter identifies that one or more data pages have the dirty status indication.

11. An apparatus as in Clause 9 or Clause 10, wherein:
the data pages are migrated via transfer of corresponding migration packages from the source processing platform to the destination processing platform;
the plurality of counters maintained by the integrity checking circuitry comprise an inflight counter indication for each migration stream used to identify a number of the migration packages issued by that migration stream to the destination processing platform that have yet to be processed by the destination processing platform; and
the integrity checking circuitry is configured to determine that the set of integrity checking rules are failed when any of the inflight counter indications indicate that at least one issued migration package is still to be processed by the destination processing platform.

12. An apparatus as in Clause 11, wherein:
the plurality of counters maintained by the integrity checking circuitry comprise a source migration counter for each migration stream whose value is used to indicate how many migration packages have been issued by that migration stream to the destination processing platform;
for each migration package issued to the destination processing platform by a given migration stream, an indication of the associated source migration counter value is provided as metadata in that migration package;
the destination processing platform is configured, for each migration stream, to use the source migration counter value indications provided as metadata in the migration packages to ensure that the migration packages are processed by the destination processing platform in a same order that they were issued by that migration stream;
the destination processing platform is configured to maintain a destination migration counter for each migration stream whose value is used to indicate how many migration packages of that migration stream have been processed by the destination processing platform; and
the integrity checking circuitry is configured to determine that the set of integrity checking rules are failed when, for any given migration stream, the values of the destination migration counter and the source migration counter indicate a mismatch.

13. An apparatus as in any preceding clause, wherein the integrity checking circuitry is configured to evaluate whether the set of integrity checking rules are satisfied in response to the management circuitry indicating a desire to transition to the phase where program instructions of the virtual machine are permitted to be executed by the destination processing circuitry, and to permit the transition if the set of integrity checking rules are satisfied.

14. An apparatus as in any preceding clause, wherein the management circuitry is configured to allocate a processing thread to each migration stream, and for a given migration stream to employ the allocated processing thread to perform the migration of data pages within the associated memory region of that migration stream.

15. An apparatus as in any preceding clause, wherein the integrity checking circuitry comprises source integrity checking circuitry on the source processing platform and destination integrity checking circuitry on the destination processing platform, and the source integrity checking circuitry and the destination integrity checking circuitry are configured to operate in combination to assess whether a set of integrity checking rules are satisfied.

16. An apparatus as in Clause 15, wherein the tracking storage comprises source tracking storage to maintain tracking information used by the source integrity checking circuitry and destination tracking storage to maintain tracking information used by the destination integrity checking circuitry.

17. A method of migrating a virtual machine from a source processing platform to a destination processing platform, comprising:
causing, by management circuitry, a migration of the virtual machine from the source processing platform to the destination processing platform, so that a future execution of program instructions associated with the virtual machine are executed by destination processing circuitry of the destination processing platform instead of source processing circuitry of the source processing platform, wherein the migration causes a number of data pages belonging to the virtual machine to be migrated from a source memory device of the source processing platform to a destination memory device of the destination processing platform;
employing a plurality of migration streams to perform the migration, where each migration stream is allocated an associated memory region that is mutually exclusive to a memory region allocated to any other migration stream in the plurality of migration streams, and each migration stream is used to migrate data pages within its associated memory region; and
checking, by integrity checking circuitry, integrity of the virtual machine during the migration with reference to tracking information maintained to indicate progress of the migration, the checking comprising using the tracking information to assess whether a set of integrity checking rules are satisfied, and to prevent the migration proceeding to a phase where program instructions of the virtual machine are permitted to be executed by the destination processing circuitry unless the set of integrity checking rules are satisfied, wherein the set of integrity checking rules are determined taking into account that any given data page is constrained to be migrated using the migration stream whose associated memory region contains the given data page.

18. A computer readable medium comprising a computer program configured, when executed by a computer, to:
provide a plurality of migration streams for use in performing a migration of a virtual machine from a source processing platform to a destination processing platform, so that a future execution of program instructions associated with the virtual machine are executed by destination processing circuitry of the destination processing platform instead of source processing circuitry of the source processing platform, the migration comprising transfer of a number of data pages belonging to the virtual machine from a source memory device of the source processing platform to a destination memory device of the destination processing platform;
allocate each migration stream an associated memory region that is mutually exclusive to a memory region allocated to any other migration stream in the plurality of migration streams, such that each migration stream is used to migrate data pages within its associated memory region;
use tracking information indicating progress of the migration to assess whether a set of integrity checking rules are satisfied; and
prevent the migration proceeding to a phase where program instructions of the virtual machine are permitted to be executed by the destination processing circuitry unless the set of integrity checking rules are satisfied;
wherein the set of integrity checking rules are determined taking into account that any given data page is constrained to be migrated using the migration stream whose associated memory region contains the given data page.

19. A system comprising:
the apparatus of any of clauses 1 to 16, implemented in at least one packaged chip;
at least one system component; and
a board,
wherein the at least one packaged chip and the at least one system component are assembled on the board.

20. A chip-containing product comprising the system of Clause 19, wherein the system is assembled on a further board with at least one other product component.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
management circuitry configured to cause a migration of a virtual machine from a source processing platform to a destination processing platform, so that a future execution of program instructions associated with the virtual machine are executed by destination processing circuitry of the destination processing platform instead of source processing circuitry of the source processing platform, wherein the management circuitry is configured to cause the migration by causing a number of data pages belonging to the virtual machine to be migrated from a source memory device of the source processing platform to a destination memory device of the destination processing platform;
integrity checking circuitry configured to check integrity of the virtual machine during the migration; and
tracking storage used to maintain tracking information indicative of progress of the migration;
wherein:
the management circuitry is configured to employ a plurality of migration streams to perform the migration, where each migration stream is allocated an associated memory region that is mutually exclusive to a memory region allocated to any other migration stream in the plurality of migration streams, and each migration stream is used to migrate data pages within its associated memory region; and
the integrity checking circuitry is configured to use the tracking information to assess whether a set of integrity checking rules are satisfied, and to prevent the migration proceeding to a phase where program instructions of the virtual machine are permitted to be executed by the destination processing circuitry unless the set of integrity checking rules are satisfied, wherein the set of integrity checking rules are determined taking into account that any given data page is constrained to be migrated using the migration stream whose associated memory region contains the given data page.

2. An apparatus as claimed in claim 1, wherein:
the virtual machine is a confidential virtual machine, and the management circuitry is prohibited from accessing the data pages of the confidential virtual machine;
the apparatus further comprises security circuitry configured to maintain security of the confidential virtual machine during the migration, and the integrity checking circuitry is provided by the security circuitry;
the security circuitry is configured, for a selected data page that the management circuitry wishes to migrate, to generate a corresponding migration package for the selected data page in which content of the selected data page is encrypted in order to inhibit access to content of the selected data page by the management circuitry, and which includes an indication of the migration stream whose associated memory region includes the selected data page; and
the management circuitry is arranged to cause the selected data page to be migrated via transfer of the corresponding migration package to the destination processing platform for handling by destination security circuitry of the destination processing platform, wherein the destination security circuitry is employed to decrypt the content prior to storing the content of the data page to the destination memory device.

3. An apparatus as claimed in claim 2, wherein the security circuitry is arranged to maintain the tracking information in the tracking storage.

4. An apparatus as claimed in claim 2, wherein the management circuitry is configured to choose the number of migration streams to be employed, up to a maximum number of migration streams supported by the security circuitry, and the security circuitry is configured to determine the associated memory region to be allocated to each migration stream in dependence on the number of migration streams chosen by the management circuitry.

5. An apparatus as claimed in claim 1, wherein for each migration stream the associated memory region comprises multiple blocks of memory addresses.

6. An apparatus as claimed in claim 5, wherein for each migration stream the blocks of memory addresses forming the associated memory region are interleaved with blocks of memory addresses forming the associated memory regions of each other migration stream.

7. An apparatus as claimed in claim 6, wherein the plurality of migration streams comprise N migration streams, and for each migration stream the blocks of memory addresses forming the associated memory region are separated by a regular stride so as to comprise every Nth block within an area of memory containing the data pages belonging to the virtual machine, and each block of memory addresses is only allocated to one migration stream.

8. An apparatus as claimed in claim 5, wherein:
the program instructions of the virtual machine are configured to refer to virtual memory addresses, the virtual machine is configured to manage a stage 1 address translation used to translate a given virtual address into a given intermediate address, and the management circuitry is configured to at least partly manage a stage 2 address translation used to translate the given intermediate address into a given physical address;
the stage 2 address translation comprises reference to a series of page tables ending in a leaf page table provided for an area of memory address space of a predetermined size X; and
each block of memory addresses forming the associated memory region of a given migration stream is of the predetermined size X.

9. An apparatus as claimed in claim 1, wherein:
the tracking information comprises a plurality of counters maintained by the integrity checking circuitry;
the integrity checking circuitry is configured to determine, at a given point in time, that the set of integrity checking rules are satisfied when the plurality of counters have values that guarantee that the integrity of the virtual machine will be met were the migration to proceed, at that given point in time, to the phase where program instructions of the virtual machine are permitted to be executed by the destination processing circuitry.

10. An apparatus as claimed in claim 9, wherein:
the integrity checking circuitry is configured to maintain data page status information identifying, for each data page belonging to the virtual machine, a migration status of that data page selected from a plurality of migration status indications;
one of the migration status indications comprises a dirty status indication that, when set as the migration status for a given data page, indicates that the given data page has been migrated to the destination processing platform, but subsequently content of the given data page has been changed on the source processing platform;
the plurality of counters maintained by the integrity checking circuitry comprises a dirty page counter whose value records the number of data pages that are identified by the data page status information as having the dirty status indication; and
the integrity checking circuitry is configured to determine that the set of integrity checking rules are failed when the dirty counter identifies that one or more data pages have the dirty status indication.

11. An apparatus as claimed in claim 9, wherein:
the data pages are migrated via transfer of corresponding migration packages from the source processing platform to the destination processing platform;
the plurality of counters maintained by the integrity checking circuitry comprise an inflight counter indication for each migration stream used to identify a number of the migration packages issued by that migration stream to the destination processing platform that have yet to be processed by the destination processing platform; and
the integrity checking circuitry is configured to determine that the set of integrity checking rules are failed when any of the inflight counter indications indicate that at least one issued migration package is still to be processed by the destination processing platform.

12. An apparatus as claimed in claim 11, wherein:
the plurality of counters maintained by the integrity checking circuitry comprise a source migration counter for each migration stream whose value is used to indicate how many migration packages have been issued by that migration stream to the destination processing platform;
for each migration package issued to the destination processing platform by a given migration stream, an indication of the associated source migration counter value is provided as metadata in that migration package;
the destination processing platform is configured, for each migration stream, to use the source migration counter value indications provided as metadata in the migration packages to ensure that the migration packages are processed by the destination processing platform in a same order that they were issued by that migration stream;
the destination processing platform is configured to maintain a destination migration counter for each migration stream whose value is used to indicate how many migration packages of that migration stream have been processed by the destination processing platform; and
the integrity checking circuitry is configured to determine that the set of integrity checking rules are failed when, for any given migration stream, the values of the destination migration counter and the source migration counter indicate a mismatch.

13. An apparatus as claimed in claim 1, wherein the integrity checking circuitry is configured to evaluate whether the set of integrity checking rules are satisfied in response to the management circuitry indicating a desire to transition to the phase where program instructions of the virtual machine are permitted to be executed by the destination processing circuitry, and to permit the transition if the set of integrity checking rules are satisfied.

14. An apparatus as claimed in claim 1, wherein the management circuitry is configured to allocate a processing thread to each migration stream, and for a given migration stream to employ the allocated processing thread to perform the migration of data pages within the associated memory region of that migration stream.

15. An apparatus as claimed in claim 1, wherein the integrity checking circuitry comprises source integrity checking circuitry on the source processing platform and destination integrity checking circuitry on the destination processing platform, and the source integrity checking circuitry and the destination integrity checking circuitry are configured to operate in combination to assess whether a set of integrity checking rules are satisfied.

16. An apparatus as claimed in claim 15, wherein the tracking storage comprises source tracking storage to maintain tracking information used by the source integrity checking circuitry and destination tracking storage to maintain tracking information used by the destination integrity checking circuitry.

17. A method of migrating a virtual machine from a source processing platform to a destination processing platform, comprising:
causing, by management circuitry, a migration of the virtual machine from the source processing platform to the destination processing platform, so that a future execution of program instructions associated with the virtual machine are executed by destination processing circuitry of the destination processing platform instead of source processing circuitry of the source processing platform, wherein the migration causes a number of data pages belonging to the virtual machine to be migrated from a source memory device of the source processing platform to a destination memory device of the destination processing platform;
employing a plurality of migration streams to perform the migration, where each migration stream is allocated an associated memory region that is mutually exclusive to a memory region allocated to any other migration stream in the plurality of migration streams, and each migration stream is used to migrate data pages within its associated memory region; and
checking, by integrity checking circuitry, integrity of the virtual machine during the migration with reference to tracking information maintained to indicate progress of the migration, the checking comprising using the tracking information to assess whether a set of integrity checking rules are satisfied, and to prevent the migration proceeding to a phase where program instructions of the virtual machine are permitted to be executed by the destination processing circuitry unless the set of integrity checking rules are satisfied, wherein the set of integrity checking rules are determined taking into account that any given data page is constrained to be migrated using the migration stream whose associated memory region contains the given data page.

18. A computer readable medium comprising a computer program configured, when executed by a computer, to:
provide a plurality of migration streams for use in performing a migration of a virtual machine from a source processing platform to a destination processing platform, so that a future execution of program instructions associated with the virtual machine are executed by destination processing circuitry of the destination processing platform instead of source processing circuitry of the source processing platform, the migration comprising transfer of a number of data pages belonging to the virtual machine from a source memory device of the source processing platform to a destination memory device of the destination processing platform;
allocate each migration stream an associated memory region that is mutually exclusive to a memory region allocated to any other migration stream in the plurality of migration streams, such that each migration stream is used to migrate data pages within its associated memory region;
use tracking information indicating progress of the migration to assess whether a set of integrity checking rules are satisfied; and
prevent the migration proceeding to a phase where program instructions of the virtual machine are permitted to be executed by the destination processing circuitry unless the set of integrity checking rules are satisfied;
wherein the set of integrity checking rules are determined taking into account that any given data page is constrained to be migrated using the migration stream whose associated memory region contains the given data page.

19. A system comprising:
the apparatus of claim 1, implemented in at least one packaged chip;
at least one system component; and
a board,
wherein the at least one packaged chip and the at least one system component are assembled on the board.

20. A chip-containing product comprising the system of claim 19, wherein the system is assembled on a further board with at least one other product component.
